(19) United States
(12) Patent Application Publication
(10) Pub. No.: US 2005/0180175 A1
(43) Pub. Date: Aug. 18, 2005

(54) Inverter topology for utility-interactive distributed generation sources

(76) Inventors: David A. Torrey, Ballston Spa, NY (US); Supat Kittiratsatcha, Bangkok (TH); Travis B. Bashaw, Peru, NY (US); Robert T. Carpenter, Cohoes, NY (US)

Correspondence Address: HOFFMAN WARNICK & D'ALESSANDRO, LLC, 3 E-COMM SQUARE, ALBANY, NY, 12207, US

(21) Appl. No.: 10/777,258

(22) Filed: Feb. 12, 2004

(51) Int. Cl. H02M 3/335

(52) U.S. Cl. 363/17

(57) ABSTRACT

An inverter system for delivering energy from a source of direct current (dc) to an alternating current (ac) utility is provided. The inverter system comprises a dc/dc converter coupled to the source of dc for synthesizing a time-varying current from the dc, an output inductor coupled to the dc/dc converter, and an inverter coupled to the output inductor for supplying the time-varying current to the ac utility in phase with a voltage of the ac utility.

### BACKGROUND OF THE INVENTION

1. Technical Field

The present invention relates generally to inverters for converting direct current (dc) to alternating current (ac). More specifically, the present invention provides an improved inverter topology for use with distributed generation sources such as solar photovoltaic (PV) cells.

2. Related Art

Distributed generation sources that produce direct current (dc) require an inverter to convert the dc into alternating current (ac) where there is a desire or need to deliver that energy to an alternating current (ac) utility. Traditionally, distributed generation inverters, such as those used to deliver energy from solar photovoltaic (PV) cells to an ac utility, are comprised of multiple conversion stages, wherein each conversion stage has its own control. Taken collectively, the multiple conversion stages generally use a dc/dc converter that is responsible for preferentially loading the solar PV cells in order to maximize the power that is produced by the solar PV cells. The output of this dc/dc converter is typically a fixed dc voltage that is used to supply energy to an inverter that is connected to the ac utility. In many situations it is desired to have electrical isolation between the ac utility and the solar PV cells. A common approach for providing this isolation is to use a transformer between the output inverter and the ac utility.

In a paper by Kjaer, Pedersen and Blaabjerg, “Power Inverter Topologies for Photovoltaic Modules—A Review” (IEEE Industry Applications Society Annual Meeting, 2002), incorporated herein by reference, there is provided an overview of inverter topologies used to interface solar PV modules to an ac utility; details for many of the inverter topologies are contained in the references cited therein. This paper identifies an inverter topology 10 that accomplishes the conversion in a single stage, shown in FIG. 1. This approach is based on a bidirectional flyback converter, thereby limiting it to relatively low power levels, typically 1 kW and under. Above about 1 kW the flyback converter becomes impractical compared to other inverter technologies.

Another inverter topology 20 discussed by Kjaer et al. is shown in FIG. 2. Inverter topology 20 uses a resonant dc/dc converter to feed a grid-connected inverter. The resonant dc/dc converter maintains low switching loss. However, the switch ratings are increased, as are transformer currents. The output inverter uses both line frequency and high frequency switching. In inverter topology 20, the output inverter is responsible for maximum power point tracking (MPPT). The function of MPPT is discussed in greater detail below.

A third inverter topology 30 discussed by Kjaer et al. is shown in FIG. 3. Inverter topology 30 has three distinct sections. The first section is a down converter that controls the voltage fed to a series resonant converter. The transformer integral to the series resonant converter provides isolation between the ac utility and the solar PV module. The series resonant converter feeds an inverter that switches at the line frequency. Losses in the inverter are kept low by virtue of the low switching frequency. However, the series resonant converter suffers from higher current ratings in the switches and transformer, similar to the inverter topology 20 shown in FIG. 2.

Yet another inverter topology 40 discussed by Kjaer et al is shown in FIG. 4. Inverter topology 40 also has three stages. The first stage is a boost converter that increases the output voltage of the solar PV module. The second stage is a dc/dc converter known as a push-pull converter. This stage is responsible for generating current in the output inductor that looks like a rectified sine wave. This output current is then directed into the ac utility through an output inverter that switches at the line frequency. The use of the boost converter is blamed for the relatively low overall efficiency of the system.

The inverter topology 50 shown in FIG. 5 also uses three stages and is similar to the inverter topology 40 shown in FIG. 4, except that galvanic isolation is now built into the boost converter by using a current fed push-pull converter to draw current from the solar PV module. A buck (or down) converter is used for shaping the current that is directed into the ac utility by the output inverter. It will be appreciated that the boost converter and the buck converter are working against one another to some extent, in that the buck converter is reducing the voltage after the boost converter has increased it.

With this information as background, it will be appreciated that it is desirable to reduce the number of conversion stages within the inverter system. Further, it will be appreciated that using resonant conversion within the inverter system tends to increase cost and lower efficiency since the resonant conversion process increases switch and transformer currents. However, it is important to provide galvanic isolation between the ac utility and the solar PV module as a safety precaution, and a high frequency transformer is far more compact and lighter than a line frequency transformer.

In U.S. Pat. No. 4,445,049 to Steigerwald, incorporated herein by reference, there is disclosed an inverter system for interfacing a dc source with an ac utility. The invention focuses on providing currents of high power factor to the ac utility. The converter used to accomplish this makes use of controllable switches (bipolar junction transistors) to regulate the current provided to a transformer. Two thyristors are used to alternately supply the regulated current to a transformer that is connected to the ac utility. In this implementation the transformer is large and heavy because it operates at the ac utility frequency. The power factor is a combined measure of the phase relationship between the current and voltage and the distortion of the phase current, and its importance is discussed below.

In U.S. Pat. No. 5,742,496 to Tsutsuni, incorporated herein by reference, there is disclosed an inverter system for converting a dc voltage into a single-phase ac voltage. This inverter system uses a high frequency transformer to reduce size and weight. However, the transformer used in this inverter system must store energy in order to support converter operation. This use of the transformer for intermediate energy storage tends to increase the voltage and current stress on the semiconductor switches. Typically, converters that use transformers for energy storage (sometimes referred to as flyback converters) are limited in the amount of power that they can process efficiently, as in the inverter topology 10 shown in FIG. 1.

In U.S. Pat. No. 4,864,479 Steigerwald and Ngo, incorporated herein by reference, there is disclosed a full-bridge switching converter intended for dc/dc conversion. This converter makes use of parasitic circuit elements to help reduce the losses within the converter. The parasitic elements used include the output capacitance of the MOSFETs that form the full bridge and the magnetizing and leakage inductances of the high frequency transformer. Single frequency operation is accomplished over a broad range of output conditions by phase shifting the operation of the converter legs relative to one another.

Power factor is also an important consideration in the operation of an inverter system that provides energy to an ac utility. Power factor is comprised of two components in power electronic systems of the type discussed herein. The first component of the power factor is the displacement power factor and describes the phase relationship between the fundamental of the voltage and the fundamental of the current. For the power systems described herein, it is generally assumed that the utility voltage is a sinusoidal waveform containing only one frequency. In this case, the displacement power factor is the phase shift between the fundamental of the current and the utility voltage. The second component of the power factor is the distortion power factor and describes the relationship between the fundamental component of the ac utility current to the total current waveform. The power factor is less than or equal to one by definition. The higher the power factor, the smaller the phase shift between the voltage and current, and the lower the distortion of the current.

For any given distributed generation energy source, there is an interest in extracting as much energy from the source as possible. This implies that conversion efficiency is important, as is optimal loading of the energy source. This optimal loading is often referred to as maximum power point tracking (MPPT). That is, the voltage provided by the distributed generation energy source depends on the current supplied by the energy source. Since dc power is the product of dc voltage and dc current, it is desired to operate the distributed generation energy source at a voltage such that the product of the voltage and current is maximized for the operating conditions of the energy source. For example, the energy output by an array of solar cells depends on the temperature of the cells and the amount of sunlight incident upon the solar cells. For most energy sources the voltage naturally reduces as the current drawn from the source increases. Beyond some current loading, the voltage begins to reduce much more rapidly and the product of voltage and current begins to go down as more current is drawn from the energy source. The MPPT algorithm is trying to maintain the current draw such that the product of voltage and current is maximized. It is important for any inverter system to make provisions for supporting MPPT.

A common approach to the design of a dc/ac inverter system is to use a dc/dc converter to optimally load the energy source. The dc/dc converter serves to operate the energy source at its maximum power point while outputting a constant dc voltage. The constant dc voltage output by the dc/dc converter is then passed through an inverter that converts the dc into ac. This approach uses two converters configured so that all power must pass through each converter. The overall efficiency is therefore the product of the efficiencies associated with each stage. As discussed above, there are sometimes other approaches taken that may result in combining the two converters into a single stage, while other approaches may use still more stages.

In view of the foregoing description of the prior art relative to inverter topologies for an ac utility interface, it will be appreciated that these inverter topologies contain one or more of the following deficiencies: reliance on a low frequency isolation transformer that is large and heavy; reliance on an isolation transformer that must store magnetic energy (this approach is impractical for applications that must support more than about 1 kW of power flow); reliance on resonant converter subsections that tend to increase component stress and can be difficult to control over wide ranges of load; reliance on converter stages that accomplish a specific task, but do so by effectively working against another stage of the topology (e.g., a buck converter stage cascaded with a boost converter stage). There is a need, therefore, for an improved inverter topology that overcomes the above-described deficiencies.

### SUMMARY OF THE INVENTION

The present invention provides an improved inverter topology for use with distributed generation sources. In particular, distributed generation sources, such as solar photovoltaic (PV) cells that produce direct current (dc), require an inverter to convert the dc into alternating current (ac) in order to deliver energy to an ac utility. The disclosed inverter topology of the present invention maximizes the interaction between cascaded conversion stages to reduce the number of parts, reduce the cost, improve the efficiency and improve the reliability of the inverter topology.

A first aspect of this invention is directed to an inverter system for delivering energy from a source of direct current (dc) to an alternating current (ac) utility, comprising: a dc/dc converter coupled to the source of dc for synthesizing a time-varying current from the dc; an output inductor coupled to the dc/dc converter; and an inverter coupled to the output inductor for supplying the time-varying current to the ac utility in phase with a voltage of the ac utility.

A second aspect of this invention is directed to a method for delivering energy from a source of direct current (dc) to an alternating current (ac) utility, comprising: synthesizing a time-varying current from the dc using a dc/dc converter; smoothing the time-varying current; and supplying the time-varying current to the ac utility in phase with a voltage of the ac utility.

A third aspect of the present invention is directed to an apparatus, comprising: an alternating current (ac) utility; a source of direct current (dc); and an inverter system for delivering energy from the source of dc to the ac utility; wherein the inverter system comprises: a dc/dc converter coupled to the source of dc for synthesizing a time-varying current from the dc; an output inductor coupled to the dc/dc converter; and an inverter coupled to the output inductor for supplying the time-varying current to the ac utility in phase with a voltage of the ac utility.

The foregoing and other features of the invention will be apparent from the following more particular description of embodiments of the invention.

### BRIEF DESCRIPTION OF THE DRAWINGS

The embodiments of this invention will be described in detail, with reference to the following figures, wherein like designations denote like elements, and wherein:

FIG. 1 depicts a single-stage inverter topology of the prior art including a bidirectional flyback converter.

FIG. 2 depicts an inverter topology of the prior art based on a resonant dc/dc converter and a modified bridge inverter.

FIG. 3 depicts a three-stage inverter topology of the prior art including a buck (down) converter, a series resonant converter, and an output inverter.

FIG. 4 depicts a three-stage inverter topology of the prior art including a boost converter, a dc/dc (push-pull) converter, and an output inverter.

FIG. 5 depicts a three-stage inverter topology of the prior art including a current fed push-pull converter, a buck (down) converter, and an output inverter.

FIG. 6 depicts an improved inverter topology in accordance with the present invention.

FIG. 7 depicts the quasi-square alternating voltage waveform applied to the primary of the transformer of the inverter of the present invention.

FIG. 8 depicts the impact of a commutation process on a transformer secondary voltage relative to the voltage applied to the primary of the transformer.

FIG. 9 depicts measured voltage and current waveforms for an inverter topology in accordance with the present invention.

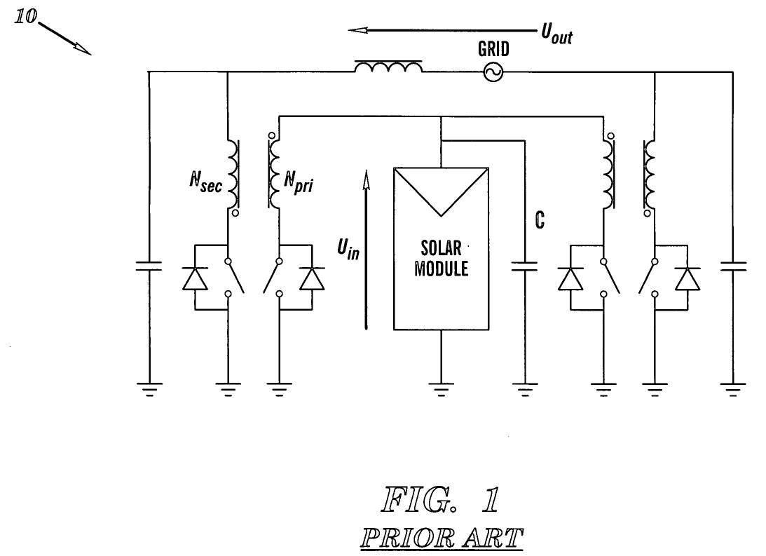

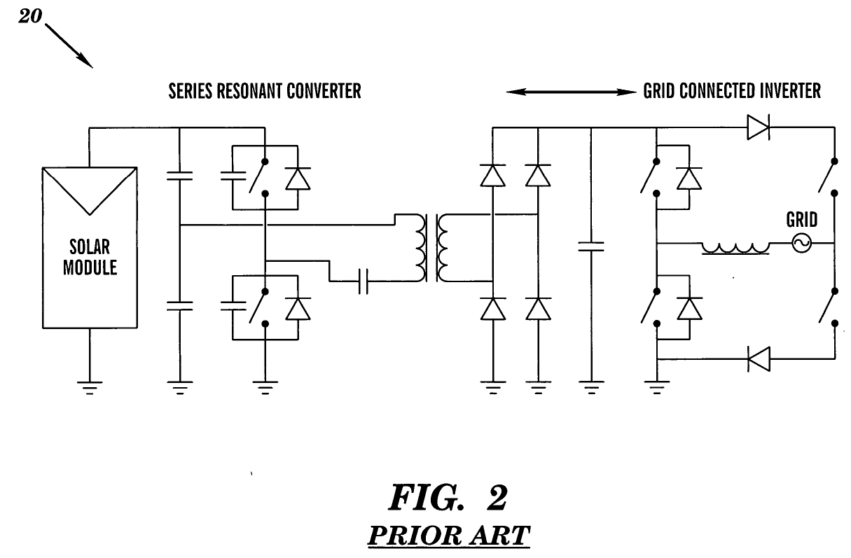

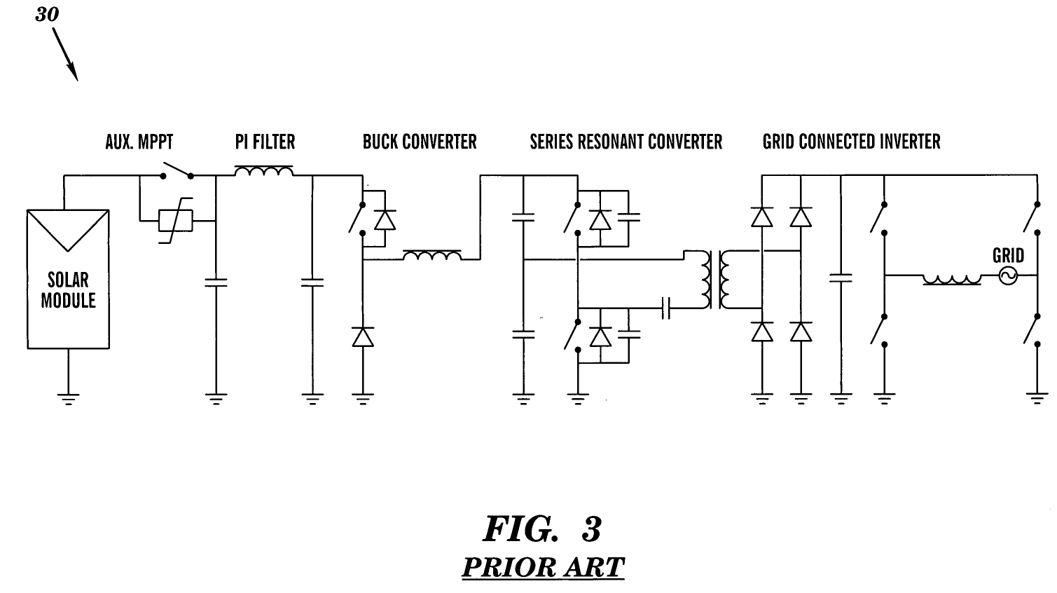

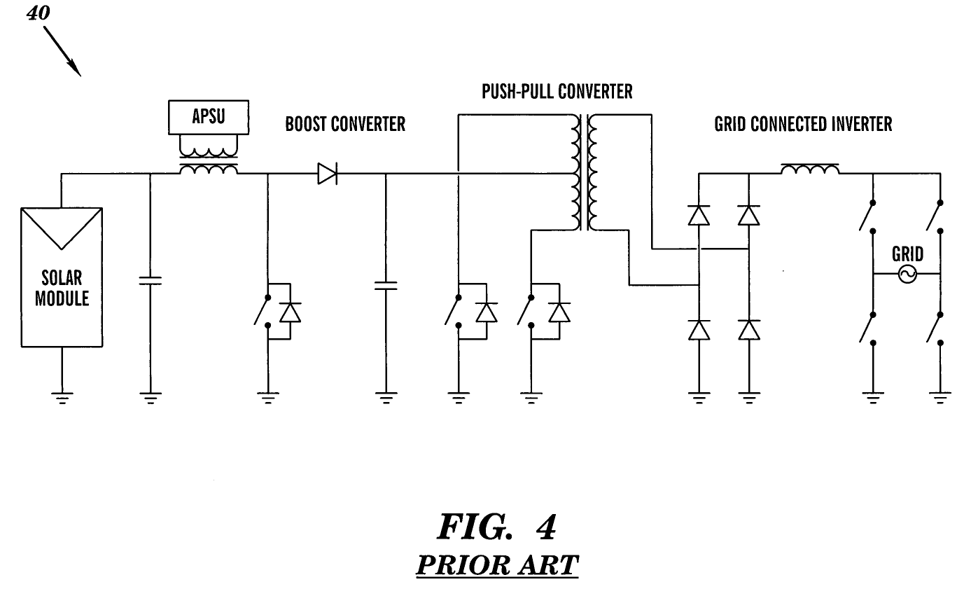

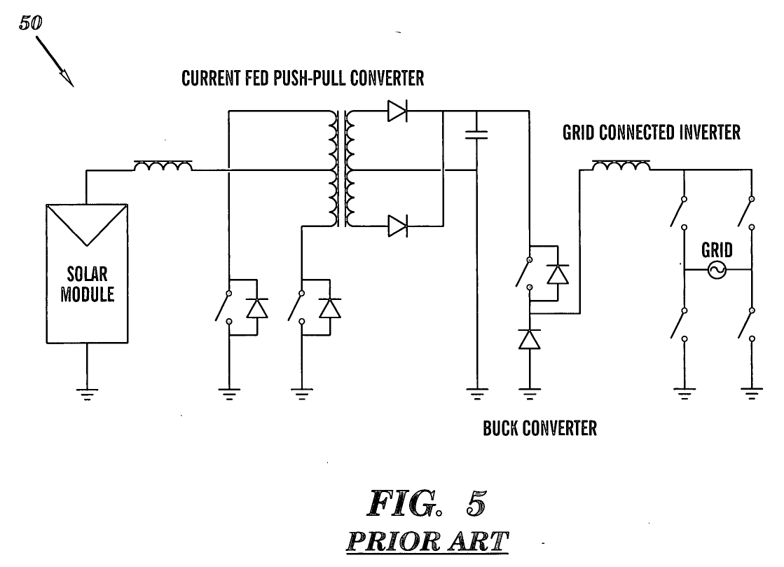

### DETAILED DESCRIPTION OF THE INVENTION

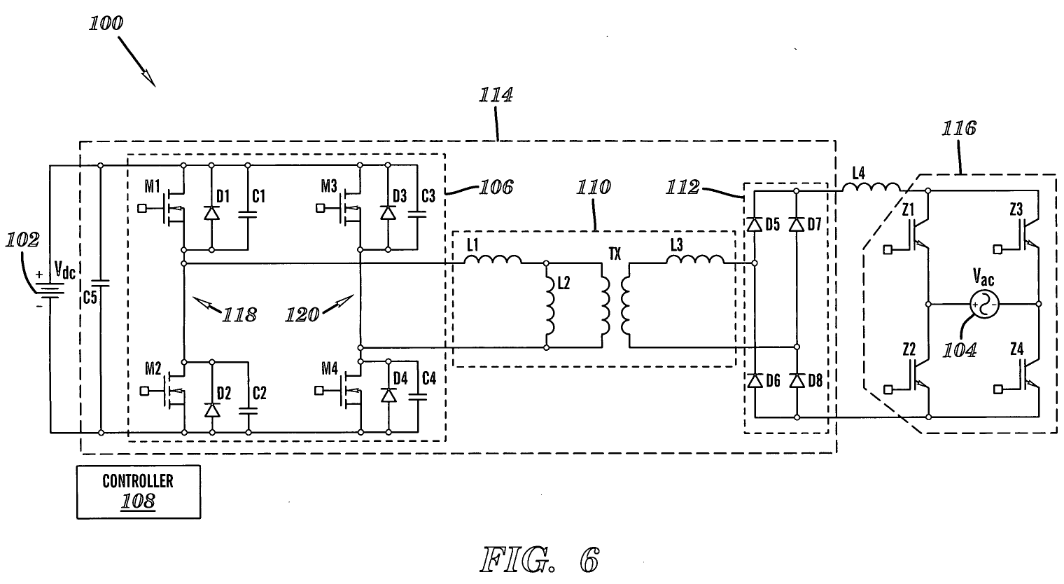

FIG. 6 illustrates an improved inverter system 100 in accordance with the present invention. In FIG. 6, Vdc 102 represents the source of direct current (dc). Vdc 102 may comprise one or more solar photovoltaic cells, a fuel cell, the rectified output of an alternator, a battery, a supercapacitor, etc. Vac 104 represents the alternating current (ac) utility. Switches M1-M4 on the input side form a phase-shifted input bridge 106, and may comprise metal oxide semiconductor field effect transistors (MOSFETs), a type of fully controllable semiconductor switch. Diodes D1-D4 and capacitors C1-C4 represent the body diodes and output capacitors of the MOSFETs M1-M4, respectively. That is, D1-D4 and C1-C4 are parasitic elements contained within the MOSFETs M1-M4. One skilled in the art will appreciate that other types of semiconductor switches can be used instead of MOSFETs, however, it may be necessary to use discrete physical components to emulate the parasitic elements (i.e., D1-D4 and C1-C4) of the MOSFETs M1-M4. MOSFETs M1-M4 are selectively turned on and off through gate drive circuits that respond to a controller 108. The controller 108 may be analog, digital, or some combination of the two.

Inductors L1, L2 and L3 together with transformer TX are used to represent the isolation transformer 110 in the inverter system 100. Inductors L1 and L3 represent the leakage inductance on the primary and secondary sides of the transformer 110, respectively. Inductor L2 represents the magnetizing branch of the transformer 110. A real transformer also has resistance in each winding, a resistance in parallel with the magnetizing branch to represent core loss, and capacitance between the primary and secondary windings and between turns within the primary and secondary windings. These parasitic resistances and capacitances are not shown in FIG. 6. A well-designed transformer will seek to minimize the leakage inductances, the winding resistances, the core losses and the capacitances. The following description does not consider the effects of the winding resistances, core losses or parasitic capacitances.

Diodes D5-D8 in the output side of the inverter system 100 form an uncontrolled bridge rectifier 112 that is responsible for converting the bipolar voltage pulses output by the transformer 110 into unipolar voltage pulses. The bridge rectifier 112, transformer 110, and phase-shifted input bridge 106 together form a dc/dc converter 114. As will be presented in greater detail below, the dc/dc converter 114, in response to controller 108, produces a variable current in an output inductor L4. The variable current in output inductor L4 fluctuates by virtue of a time-varying phase-shift produced by the phase-shifted input bridge 106 in response to signals from the controller 108.

Output inductor L4 is used to smooth the current that flows to the ac utility (Vac 104) from the dc/dc converter 114. This effectively converts the voltage pulses output by the bridge rectifier 112 (D5-D8) into a controlled current. The current through output inductor L4 is alternately directed or “unfolded” into the ac utility (Vac 104) through an inverter 116 comprising switches Z1-Z4. As shown in FIG. 6, the switches Z1-Z4 can be implemented with insulated gate bipolar transistors (IGBTs). Other switches can be used to alternately direct the current flowing through output inductor LA into the utility in phase with the ac utility voltage. For example, the switches Z1-Z4 may comprise MOSFETs, bipolar junction transistors or thyristors.

The instantaneous power delivered to the ac utility contains an average component and a time-varying component. This is by virtue of the ac utility voltage and current both being sinusoidal with the instantaneous power being equal to their product. Because of conservation of instantaneous power, the power drawn at the input of the inverter system 100 must also vary with time. Capacitor C5 is used at the input of the phase-shifted input bridge 106 of the dc/dc converter 114 to reduce the alternating current that is drawn from the distributed generation source (i.e., Vdc 102) and to reduce the amount of variation in Vdc 102 that is caused by the fluctuating power. This is important to prevent periodic movement away from the operating point of maximum power.

Generally, the intended operation of the inverter topology shown in FIG. 6 is easiest to understand by starting at the ac utility (Vac 104) and working backward. Switches Z1-Z4 operate in synchronism with the zero crossings of the ac utility voltage, such that the voltage across the phase leg containing Z1 and Z2 is the absolute value of the utility voltage. (This neglects the small voltage drop across switches Z1-Z4.) This is accomplished by forcing Z1 and Z4 to conduct during the positive half-cycle of the utility voltage. Similarly, Z2 and Z3 are forced to conduct during the negative half-cycle of the utility voltage. Because the current through output inductor L4 is synchronized with the utility voltage, the current through the switches Z1-Z4 is crossing through zero when the switches Z1-Z4 are switched. To this extent, the switches Z1-Z4 do not switch any current, and the inverter 116 is very efficient.

The switches Z1-Z4 operate at the line frequency of the ac utility (Vac 104), with each switch conducting one-half of the time. Control of the switches Z1-Z4 can be provided by controller 108 or other suitable controller. Because the present invention seeks to provide a time-varying current to the ac utility (Vac 104) that is in phase with the utility voltage, the current through output inductor L4 should look like a rectified sinusoid that is in phase with the rectified utility voltage (i.e., the current through output inductor L4 varies at the same frequency (e.g., 50-60 Hz) as the ac utility (Vac 104)). As such, the controller 108 seeks to force the time-varying current through output inductor L4 to have the same shape as the voltage across the series combination of Z1 and Z2.

By controlling the voltage output by the bridge rectifier 112 (D5-D8), it is possible to regulate the shape of the current through output inductor L4. The voltage output by the bridge rectifier 112 (D5-D8) is governed by the switching that takes place on the primary side of the transformer 110 through the MOSFETs M1-M4 and diodes D1-D4 of the phase-shifted input bridge 106. This switching is regulated by the controller 108. The switching operations at the transformer 110 primary due to the operation of the phase-shifted input bridge 106 create a quasi-square alternating voltage waveform, such as the waveform shown in FIG. 7.

FIG. 7 illustrates the concept of phase shifting the operation of the two phase legs 118 and 120 of the phase-shifted input bridge 106 in order to create a pulse stream that is applied to the primary of the transformer 110 winding. In FIG. 7, SI refers to the collective operation of M1 and D1, with S₂-S₄ referring to the collective operation of the other bridge MOSFETs and diodes, respectively. (This discussion ignores the presence of capacitors C1-C4 for the time being. Their influence is discussed below.) When S₁ is conducting, the voltage at the midpoint of phase leg 118 will be Vdc. When S2 is conducting, the voltage at the midpoint of phase leg 118 will be zero. Similar reasoning applies to the phase leg 120 containing S3 and S4. The voltage applied to the transformer 110 primary is the difference between the midpoint voltages of the two phase legs 118, 120, as shown in FIG. 7. By shifting the phase relationship between the two midpoint voltages (e.g., by shifting S4 relative to S1 and/or S3 relative to S2), it is possible to adjust the width of the nonzero voltage pulses of the transformer primary voltage as a function of time. To this extent, a time-varying current is created in output inductor L4 by the time-varying output of the dc/dc converter 114 of the present invention.

It will be appreciated that the operation of the phase legs 118, 120 in FIG. 6 takes place at the same frequency. There are several benefits to making this frequency as high as practical. Because transformer size is inversely proportional to frequency, operation at high frequency allows minimization of transformer size. In addition, the frequency of operation sets the upper limit on the bandwidth with which the current through output inductor L4 may be controlled. Therefore, more accurate control of the current through output inductor L4 is facilitated by higher switching frequency. In a practical example, the switching frequency may be in the range of 50 kHz to 200 kHz (i.e., the switching frequency is substantially greater than the line frequency of the utility voltage and the switching frequency of the inverter 116). Other switching frequencies are also possible. It will be appreciated that the selection of the switching frequency requires balancing several competing objectives.

In conventional dc/dc converters, the phase shift between the operation of the two phase legs is nominally constant in order to regulate the output voltage. The phase shift between the phase legs is adjusted through a closed-loop controller in order to regulate the output voltage. The approach taken by the present invention is different, however, because the objective is to force the current through output inductor L4 to vary in time. Operation of the controller 108 forces the phase shift between the two phase legs 118, 120 to vary as required to force the current through output inductor LA to follow the desired wave shape, specifically a rectified sinusoid. Thus, the present invention attaches time-varying control to the phase-shift between the two legs 118, 120 of the phase-shifted input bridge 106 of the dc/dc converter 114 to synthesize an ac waveform at the output of the bridge rectifier 112 (D5-D8) (i.e., in output inductor L4).

While high switching frequency is desirable, one experienced in power electronics will appreciate that the switching frequency of the phase-shifted input bridge 106 cannot be made arbitrarily high. As the switching frequency is raised the transformer leakage inductances become increasingly significant in the operation of the phase-shifted input bridge 106. In addition, design of the transformer windings becomes more of a challenge at high frequencies in order to limit eddy current and proximity losses in the windings. Further, operation at higher frequencies also tends to drive more current through the parasitic transformer capacitances, complicating the design of filters to mitigate electromagnetic interference (EMI). In addition to transformer issues at high frequency, switching losses tend to increase monotonically with switching frequency. This suggests that there is some optimum switching frequency that appropriately balances efficiency, size and cost for a particular application.

The inductances of the transformer 110 are used to help reduce switching loss during normal operation. To appreciate how this is accomplished, consider a positive current flowing through inductor L1 such that the current is flowing from left to right in FIG. 6. MOSFET M1 supports this current flow. With M1 conducting, the voltage across C1 is zero (ideally) and the voltage across C2 is Vdc. When M1 is turned off, the current through L1 transfers from M1 to capacitors C1 and C2. By virtue of the direction of current flow, C1 tends to charge from zero toward Vdc while C2 tends to discharge from Vdc toward zero. When C1 has charged to Vdc and C2 has discharged to zero, diode D2 naturally turns on to pick up the current through L1. Once D2 is conducting, M2 can be turned on with zero voltage across it thereby minimizing the loss associated with the turn-on transition. It should also be noted that the turn-off loss associated with turning off M1 is also minimized by virtue of capacitor C1 holding the voltage small across M1 during the turn-off transition. This process is reversed when the current flow through L1 is reversed and M2 is initially supporting the inductor current.

Operation of the phase leg 120 containing M3 and M4 is similar to the process just described. However, it generally happens at different times because of the phase shift between the phase legs 118 and 120.

The resonant transitions when MOSFETs M1-M4 turn off cause the voltage applied to the primary of the transformer 110 to change more smoothly than is suggested in FIG. 7. Because the charging and discharging of capacitors C1-C4 dictate the transition, the primary voltage applied to the transformer 110 is continuous. Slowing down the primary voltage transitions tends to reduce the high frequencies that contribute to EMI issues. These transitions are sometimes referred to as edge resonant transitions because inductor L1 is resonating with phase leg capacitors during the transition. Once a semiconductor device begins to conduct the resonance period is ended. These phase leg transitions are also sometimes referred to as zero voltage transitions because the voltage across the device is held at zero as it turns off. This type of converter may be referred to as a zero voltage transition converter. Edge-resonant transitions of the phase legs should not be confused with a resonant converter that is characterized by larger current and/or voltage stress imposed on the semiconductor switches. The edge-resonant transitions are accomplished without increasing the voltage or current stress on the power semiconductor switches.

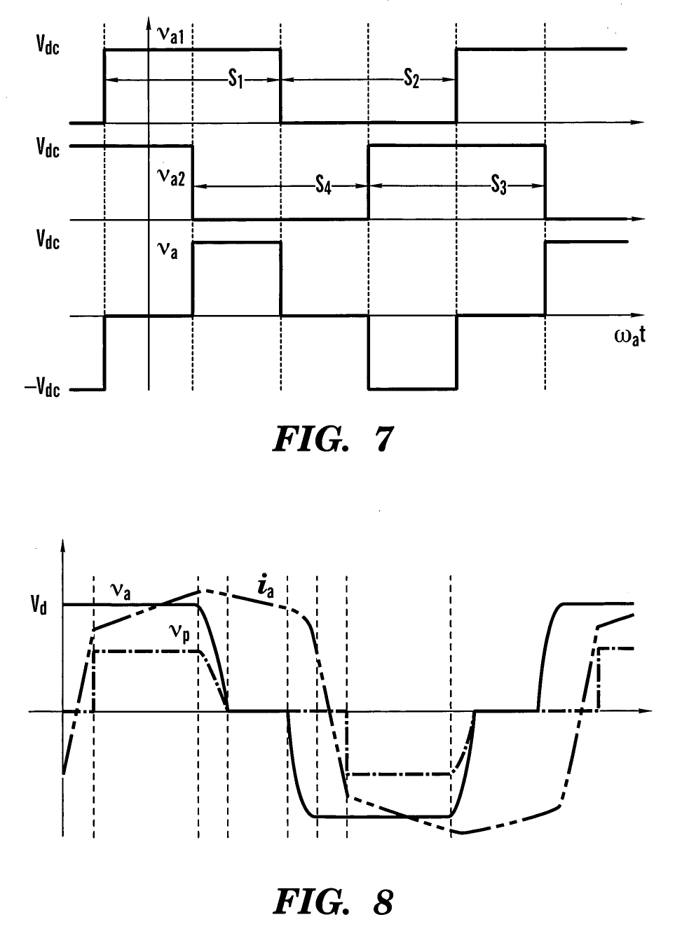

Transformer leakage and magnetizing inductance is a benefit during the switching of the MOSFETs M1-M4 in the phase-shifted input bridge 106 of the dc/dc converter 114. However, transformer inductance serves to reduce the width of the voltage pulses at the output of the bridge rectifier 112 formed by diodes D5-D8. Consider the case when diodes D5 and D8 are conducting the current through the transformer 110 secondary leakage inductance L3 and the current through output inductor L4. During this time, the voltage at the transformer 110 secondary could either be Vdc×N or zero, where N is the turns ratio of the transformer 110. When the state of the phase-shifted input bridge 106 changes on the primary of the transformer 110 such that the voltage at the secondary of TX goes negative, diodes D6 and D7 become forward biased and they are able to support current. Because of the current flowing through L3, however, diodes D5 and D8 cannot turn off instantaneously. With diodes D5-D8 all conducting, the voltage on the output side of the bridge rectifier 112 is zero and all of the negative voltage at the output of TX appears across the leakage inductance L3. The voltage across L3 forces the current through L3 to reverse. Once the current through L3 is the negative of the current through output inductor L4, the current through diodes D5 and D8 reaches zero and these diodes turn off. At this time the voltage across the output of the bridge rectifier 112 can step up to the absolute value of the voltage at the secondary of TX. This process of reversing the current flow through L3 is known as commutation. The important thing to note about commutation is that it forces the voltage at the output of the bridge rectifier 112 to be zero during the commutation process. This effectively takes voltage away from the pulses of voltage being output. FIG. 8 shows the impact of the commutation process on the transformer 110 secondary voltage vₐ relative to the voltage vₚ applied to the primary of the transformer 110. The curvature in the rising and falling edges of the primary voltage vₚ reflects the resonance between capacitors C1-C4 with inductor L1. The current waveform iₐ in FIG. 8 is approximately what the transformer 110 primary current (the current through L1) would look like for a constant current through output inductor L4.

From the preceding discussion, it will be appreciated that the parasitic elements of the transformer 110 and bridge MOSFETs M1-M4 can be used to reduce the switching losses of the phase-shifted input bridge 106 of the dc/dc converter 114. However, the transformer leakage inductance should only be allowed to be as large as necessary to accomplish efficient switching; leakage inductance that is any larger will negatively impact the performance of the converter.

The inverter topology of the present invention allows use of a single stage for output current waveform shaping (and essentially increasing the voltage to be compatible with the utility levels). The present invention provides a high bandwidth and compact converter by virtue of high switching frequency because of low switching losses due to the phase-shifted input bridge 106. The high bandwidth allows accurate tracking of the utility voltage, thereby providing current to the utility with low distortion and reduction in the physical size of inductor 110. The present invention also utilizes a low-loss inverter 116 for alternately directing the current into the utility. The inverter 116 has low losses because the switches operate at the low frequency of the utility as the switch current is passing through zero.

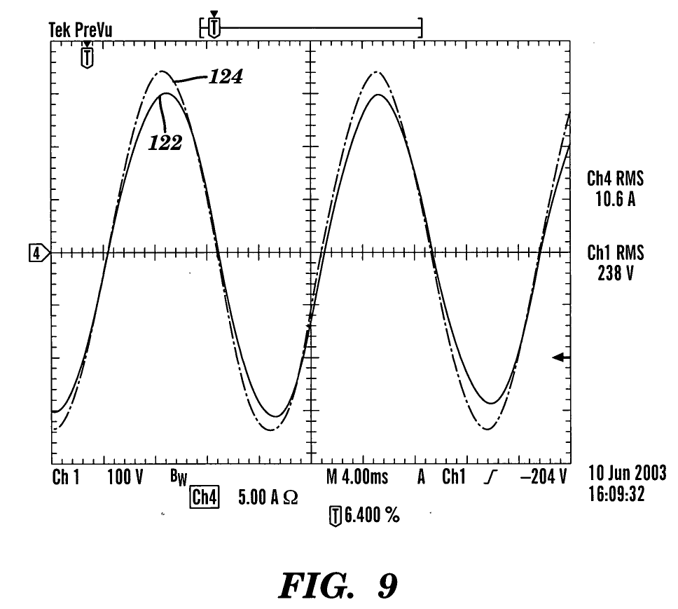

FIG. 9 shows the output current 122 and utility voltage 124 for a practical embodiment of the disclosed inverter topology. It will be observed that the quality of the output current waveform 122 is excellent, having negligible ripple and nearly identical shape as the utility voltage waveform 124.

While this invention has been described in conjunction with the specific embodiments outlined above, it is evident that many alternatives, modifications and variations will be apparent to those skilled in the art. Accordingly, the embodiments of the invention as set forth above are intended to be illustrative, not limiting. Various changes may be made without departing from the spirit and scope of the invention as defined in the following claims.

1. An inverter system for delivering energy from a source of direct current (dc) to an alternating current (ac) utility, comprising:
a dc/dc converter coupled to the source of dc for synthesizing a time-varying current from the dc;
an output inductor coupled to the dc/dc converter; and
an inverter coupled to the output inductor for supplying the time-varying current to the ac utility in phase with a voltage of the ac utility.

2. The inverter system of claim 1, wherein the dc/dc converter further comprises:
a phase-shifted input bridge coupled to the source of dc;
an isolation transformer coupled to the phase-shifted input bridge; and
a rectifier coupled to the isolation inductor.

3. The inverter system of claim 2, wherein the phase-shifted input bridge further comprises:
a first phase leg; and
a second phase leg;
wherein the inverter system further includes a controller for controlling a phase relationship between the first and second phase legs of the phase-shifted input bridge to provide the time-varying current.

4. The inverter system of claim 3, wherein the first and second phase legs of the phase-shifted input bridge each comprise a pair of switches, and wherein each switch is selectively actuated by the controller.

5. The inverter system of claim 4, wherein each switch comprises a MOSFET.

6. The inverter system of claim 4, wherein each switch comprises parasitic circuit elements, wherein the isolation transformer comprises parasitic inductances, and wherein the parasitic circuit elements and parasitic inductances reduce switching losses within the dc/dc converter.

7. The inverter system of claim 6, wherein the parasitic circuit elements of each switch comprise a parasitic diode and a parasitic capacitance.

8. The inverter system of claim 4, wherein a switching frequency of the switches is substantially greater than a line frequency of the ac utility.

9. The inverter system of claim 2, wherein the isolation transformer outputs a bipolar time-varying current, and wherein the rectifier converts the bipolar time-varying current to a unipolar time-varying current.

10. The inverter system of claim 9, wherein the output inductor smoothes the unipolar time-varying current.

11. The inverter system of claim 9, wherein the unipolar time-varying current is synchronized with zero-crossings of the ac utility voltage.

12. The inverter system of claim 1, wherein the inverter further comprises:
a first leg including first and second switches; and
a second leg including first and second switches;
wherein the ac utility is coupled to the inverter system between the first and second switches of each leg.

13. The inverter system of claim 12, further comprising:
a controller for switching the switches of the inverter at zero-crossings of the ac utility voltage.

14. The inverter system of claim 13, wherein one switch in each leg of the inverter is forced to conduct during a positive half-cycle of the ac utility voltage, and wherein the other switch in each leg of the inverter is forced to conduct during a negative half-cycle of the ac utility voltage.

15. A method for delivering energy from a source of direct current (dc) to an alternating current (ac) utility, comprising:
synthesizing a time-varying current from the dc using a dc/dc converter;
smoothing the time-varying current; and
supplying the time-varying current to the ac utility in phase with a voltage of the ac utility.

16. The method of claim 15, wherein the dc/dc converter comprises:
a phase-shifted input bridge coupled to the source of dc;
an isolation transformer coupled to the phase-shifted input bridge; and
a rectifier coupled to the isolation inductor;
wherein the method further comprises:
controlling a phase relationship between first and second phase legs of the phase-shifted input bridge to provide the time-varying current at an output of the rectifier.

17. The method of claim 16, further comprising:
reducing switching losses within the dc/dc converter using parasitic circuit elements within the phase-shifted input bridge and parasitic inductances within the isolation transformer.

18. The method of claim 16, further comprising:
outputting a bipolar time-varying current from the isolation transformer; and
converting the bipolar time-varying current to a unipolar time-varying current using the rectifier.

19. The method of claim 18, wherein the unipolar time-varying current is synchronized with zero-crossings of the ac utility voltage.

20. An apparatus, comprising:
an alternating current (ac) utility;
a source of direct current (dc); and
an inverter system for delivering energy from the source of dc to the ac utility;
wherein the inverter system comprises:
a dc/dc converter coupled to the source of dc for synthesizing a time-varying current from the dc;
an output inductor coupled to the dc/dc converter; and
an inverter coupled to the output inductor for supplying the time-varying current to the ac utility in phase with a voltage of the ac utility.

21. The apparatus of claim 20, wherein the dc/dc converter further comprises:
a phase-shifted input bridge coupled to the source of dc;
an isolation transformer coupled to the phase-shifted input bridge; and
a rectifier coupled to the isolation inductor.

22. The apparatus of claim 21, wherein the phase-shifted input bridge further comprises:
a first phase leg; and
a second phase leg;
wherein the inverter system further includes a controller for controlling a phase relationship between the first and second phase legs of the phase-shifted input bridge to provide the time-varying current.
